(19) United States
(12) Patent Application Publication
(10) Pub. No.: US 2023/0379248 A1
(43) Pub. Date: Nov. 23, 2023

(54) Adapting IPv4-only Devices for IPv6 Communication

(71) Applicant: Google LLC, Mountain View (CA)

(72) Inventors: Grant Michael Erickson, Los Altos Hills, CA (US); Jay Dare Logue, San Jose, CA (US)

(73) Assignee: Google LLC, Mountain View, CA (US)

(21) Appl. No.: 18/027,580

(22) PCT Filed: Sep. 22, 2020
(86) PCT No.: PCT/US2020/051917

§ 371 Date: Mar. 21, 2023

(51) Int. Cl. H04L 45/741; H04L 12/46

(52) U.S. Cl. CPC H04L 45/741; H04L 12/4633

(57) ABSTRACT

Techniques and devices for communicating Internet Protocol version 6 (IPv6) traffic using a lightweight Internet Protocol (LwIP) network stack and a tunnel router, by an electronic device in a first network segment of a fabric network are described. The tunnel router receives an Internet Protocol version (IPv4) address for an access router in a second network segment of the fabric network and establishes a secure IPv6-over-IPv4 network tunnel with the access router in the second network segment. The tunnel router advertises an IPv6 network route for the fabric network and, using the advertised IPv6 network route, routes IPv6 messages from the electronic device to one or more devices in the second network segment using the secure IPv6-over-IPv4 network tunnel.

### BACKGROUND

Using wireless networking to connect devices to each other, and to cloud-based services, is increasingly popular for sensing environmental conditions, controlling equipment, and providing information and alerts to users. Many devices on wireless networks are designed to operate for extended periods of time on battery-power, which limits the available computing, user interface, and radio resources in these devices. Some of these devices use host processors or network coprocessors that include Wi-Fi firmware and portions of an Internet Protocol version 4-only (IPv4-only) network stack in Read Only Memory (ROM). Other devices on wireless networks are designed to operate in a fabric network environment that exclusively communicates using Internet Protocol version 6 (IPv6) protocols.

Many devices using only IPv6 communication in the fabric network environment are provided and managed by an ecosystem provider. The devices in the fabric network environment may be provided exclusively by the ecosystem provider or devices from third-party vendors to expand the functionality provided to end users. Some third-party devices are IPv4-only devices implemented using host processors or network coprocessors that include Wi-Fi firmware and portions of an IPv4-only network stack in ROM. However, there are opportunities to enhance devices, with an IPv4-only network stack in ROM, to communicate over IPv6 fabric networks.

### SUMMARY

This summary is provided to introduce concepts of adapting IPv4-only devices for IPv6 communication, generally related to using secure tunnels to an access router in a fabric network for IPv6 communication. The concepts are further described below in the Detailed Description. This summary is not intended to identify essential features of the claimed subject matter, nor is it intended for use in determining the scope of the claimed subject matter.

In aspects, methods, devices, systems, and means for adapting IPv4-only devices for IPv6 communication are described for communicating Internet Protocol version 6 (IPv6) traffic using a lightweight Internet Protocol (LwIP) network stack and a tunnel router, by an electronic device in a first network segment of a fabric network. The tunnel router receives an Internet Protocol version 4 (IPv4) address for an access router in a second network segment of the fabric network and establishes a secure IPv6-over-IPv4 network tunnel with the access router in the second network segment. The tunnel router advertises an IPv6 network route for the fabric network and, using the advertised IPv6 network route, routes IPv6 messages from the electronic device to one or more devices in the second network segment using the secure IPv6-over-IPv4 network tunnel.

The details of one or more implementations are set forth in the accompanying drawings and the following description. Other features and advantages will be apparent from the description and drawings and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

Aspects of adapting IPv4-only devices for IPv6 communication are described with reference to the following drawings. The same numbers are used throughout the drawings to reference like features and components:

FIG. 1 illustrates an example network environment in which various aspects of adapting IPv4-only devices for IPv6 communication can be implemented.

FIG. 2 illustrates an example environment in which various aspects of adapting IPv4-only devices for IPv6 communication can be implemented.

FIG. 3 illustrates an example fabric network with which aspects of adapting IPv4-only devices for IPv6 communication can be implemented.

FIG. 4 illustrates an example block diagram of a fabric network stack model in accordance aspects of adapting IPv4-only devices for IPv6 communication.

FIG. 5 illustrates example architectures of wireless network devices that can be implemented in accordance with one or more aspects of the techniques described herein.

FIG. 6 illustrates an example of tunneling in a fabric network with which aspects of adapting IPv4-only devices for IPv6 communication can be implemented.

FIG. 7 illustrates example operations of a Lightweight Internet Protocol (LwIP) network stack, a packet switch, and a tunnel router with respect to FIG. 6 and with which aspects of adapting IPv4-only devices for IPv6 communication can be implemented.

FIG. 8 illustrates example message routing between an IPv4-only device an in-premises Ecosystem Administrative Service in accordance with aspects of adapting IPv4-only devices for IPv6 communication.

FIG. 9 illustrates an example of adapting IPv4-only devices for IPv6 communication as generally related to using secure tunnels to an access router in a fabric network for IPv6 communication in accordance with aspects of the techniques described herein.

FIG. 10 illustrates an example environment in which aspects of the techniques described herein can be implemented.

FIG. 11 illustrates an example wireless network device that can be implemented in a home area network in accordance with one or more aspects of the techniques described herein.

FIG. 12 illustrates an example system with an example device that can implement aspects of adapting IPv4-only devices for IPv6 communication.

### DETAILED DESCRIPTION

This document describes techniques and devices to accommodate devices with Internet Protocol (IP) version 4 (IPv4) network stacks in IP version 6 (IPv6) fabric networks (e.g., a Weave fabric network, a Connected Home over IP (CHIP) fabric network). Both historically and currently, some silicon devices for Internet of Things (IoT) devices include Wi-Fi firmware and an IPv4-only network and transport stack in Read-Only Memory (ROM) and provide a limited amount of writable-flash memory and Random Access memory (RAM) for product application code and data (ROMed IPv4-only devices). This approach to silicon device design can reduce development and device cost to a developer of an IoT device by simplifying software and system integration.

To the extent that the software in these ROMed IPv4-only devices can be updated, there is a desire to have these devices participate in full device-to-device, device-to-mobile, and device-to-administrative (ecosystem or vendor) service interactions in an IPv6-only application network environment. One approach to providing IPv6 connectivity to ROMed IPv4-only devices in a fabric network is to use tunneled routing to connect these ROMed IPv4-only devices to the IPv6 network fabric. For example, access routers provide connectivity to an Ecosystem Administrative Service (EAS) and one or more Vendor Administrative Services (VAS) in a fabric network for devices in the fabric network. The access routers provide tunneled connections between segments of the fabric network. These tunneled connections are encrypted to provide security and are mutually authenticated, for example, by certificates and/or key exchanges to authenticate that the network segments are segments within the same provisioned application network.

The overall administrative and operational services for an IoT deployment are managed by an Ecosystem Administrative Service (EAS) operated by the primary service provider or vendor. The EAS can be an out-of-premises EAS deployed as a cloud-based service, or the EAS can be an in-premises, device-based EAS. Whether in-premises or out-of-premises, the EAS provides services including software updates, file downloads, time of day and time synchronization, file uploads, vending of operational certificates for authentication, device and resource directories or registries, data management proxies (e.g., for commands, state, and/or settings), or the like.

The EAS provides a singular architecture and mechanism for interacting with the EAS regardless of whether the EAS is an in-premises EAS or an out-of-premises EAS and regardless of the type of network link (e.g., Wi-Fi, Ethernet, Thread) used by an IoT device. The EAS architecture also supports seamlessly and dynamically managing the transition of the EAS (or portions thereof) into and out of the premises, for example, between a cloud-based EAS and an in-premises EAS resident on a hub device.

An auxiliary Vendor Administrative Service (VAS) of a third-party vendor provides out-of-premises services (for third-party devices) that are similar to those provided by an EAS. For example, a VAS may provide software updates, file downloads (in support of software updates), file uploads (in support of crash dumps, unstructured logs, support reports, or the like), data management proxies (e.g., for commands, state, and/or settings), such as proxies in support of structured event reporting and logging, configuration/settings changes diagnostic and support commands (e.g., “dump/upload events and logs”), or the like.

By providing IPv6 connectivity to ROMed IPv4-only devices in an IPv6 fabric network using tunneled routing and access routers to connect these ROMed IPv4-only devices to the IPv6 network fabric enables these IPv4-only devices to participate as IPv6-class devices, as far as the rest of the fabric-network ecosystem is concerned. This approach provides end-to-end security between these IPv4-only devices and the rest of the fabric-network ecosystem and allows asynchronous, unsolicited ingress traffic to these IPv4-only devices by the rest of the fabric-network ecosystem. This approach does not require termination and retransmission at the access router, eliminates the need for a hub or bridge device and the traffic termination those would otherwise impose to provide IPv6 to IPv4 protocol translation. Finally, this approach eliminates the challenges and complexities of Network Address Translation (NAT), for example, inclusion, of a NAT stack, explicit end-device management of NAT port mappings, and/or out-of-band NAT-PMP security negotiation.

Example Environment

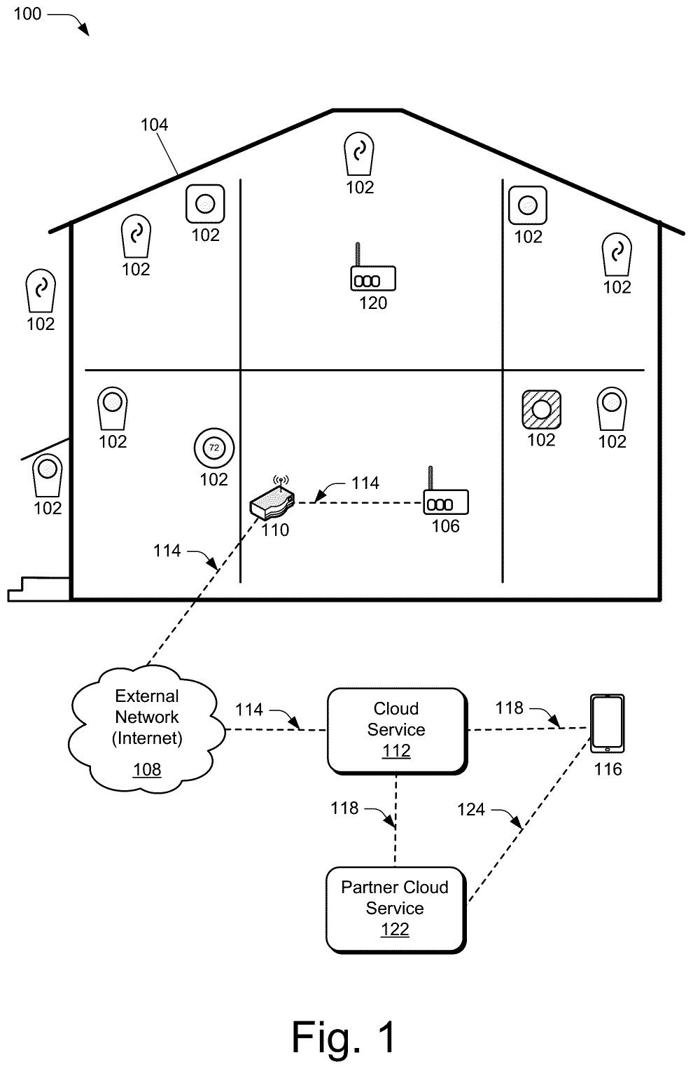

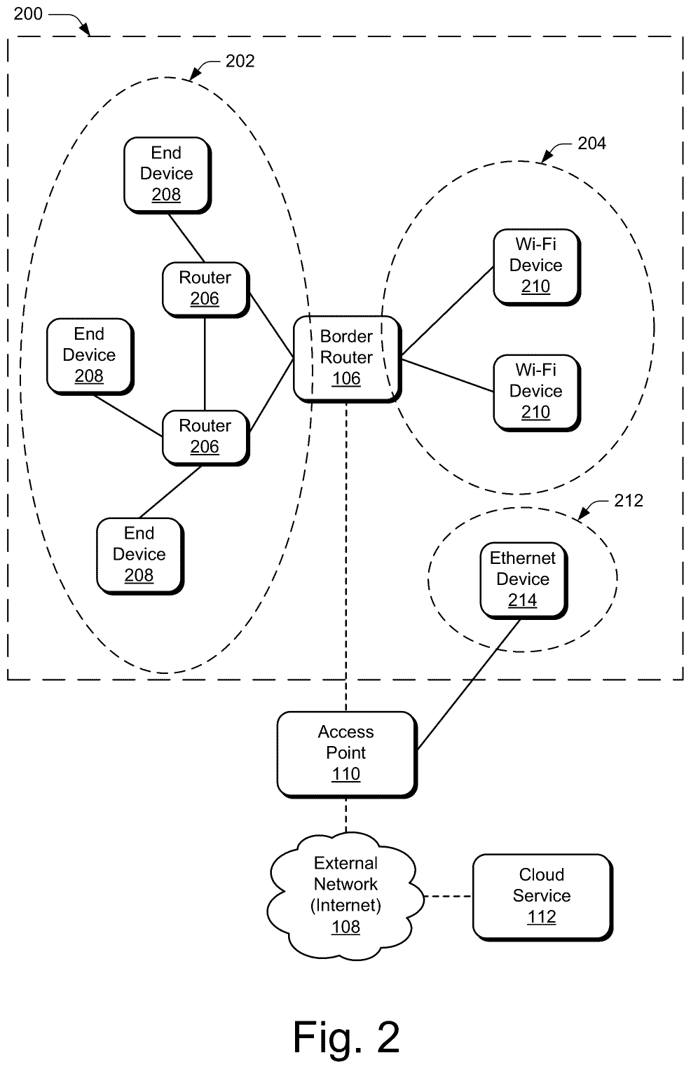

FIG. 1 illustrates an example network environment 100 in which aspects of adapting IPv4-only devices for IPv6 communication can be implemented. The network environment 100 (e.g., a fabric network, a CHIP fabric network, a Weave network) includes one or more network segments that form a home area network (HAN) such as a HAN 200, described below with respect to FIG. 2. The HAN includes wireless network devices 102 that are disposed about a structure 104, such as a house, and are connected by one or more wireless and/or wired network technologies, as described below. The HAN includes a border router 106 that connects the HAN to an external network 108 (access network 108), such as the Internet, through a home router or access point 110.

To provide user access to functions implemented using the wireless network devices 102 in the HAN, a cloud service 112 connects to the HAN via border router 106, via a secure tunnel 114 through the external network 108 (access network 108) and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers which orchestrate and arbitrate home automation experiences, as described in greater detail below. The cloud service 112 may also include an out-of-premises EAS.

The HAN may include one or more wireless network devices 102 that function as a hub 120. The hub 120 may be a general-purpose home automation hub, or an application-specific hub, such as a security hub, an energy management hub, an HVAC hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102. For example, the hub 120 (or the border router 106) may host an in-premises EAS or portions of the services provided by an EAS.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114. The partner cloud services 122 may include a VAS for support of the partner's devices.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

FIG. 2 illustrates an example environment (e.g., a fabric network, a Weave network, a CHIP fabric network) in which various aspects of adapting IPv4-only devices for IPv6 communication can be implemented. The home area network (HAN) 200 includes a wireless mesh network segment 202 (e.g., a Thread network segment), a Wi-Fi network segment 204, and/or an Ethernet segment 212. The wireless mesh network segment 202 includes routers 206 and end devices 208. The routers 206 and the end devices 208, each include a mesh network interface for communication over the mesh network segment 202. The routers 206 receive and transmit packet data over the mesh network interface. The routers 206 also route traffic across the mesh network segment 202. The end devices 208 are devices that can communicate using the mesh network segment 202, but lack the capability, beyond simply forwarding to its parent router 206, to route traffic in the mesh network segment 202. For example, a battery-powered sensor is one type of end device 208. The Wi-Fi network segment 204 includes Wi-Fi devices 210. Each Wi-Fi device 210 includes a Wi-Fi network interface for communication over the Wi-Fi network segment 204. Optionally or additionally, the HAN 200 can include an Ethernet network segment 212 that includes one or more Ethernet devices 214 that connect to the border router 106 or the access point 110.

The border router 106 is included in the wireless mesh network segment 202 and is included in the Wi-Fi network segment 204. The border router 106 includes a mesh network interface for communication over the mesh network segment 202 and a Wi-Fi network interface for communication over the Wi-Fi network segment 204. The border router 106 routes packets between devices in the wireless mesh network segment 202 and the Wi-Fi network segment 204. The border router 106 also routes packets between devices in the HAN 200 and external network nodes (e.g., the cloud service 112) via the access network 108, such as the Internet, through a home router or access point 110.

The devices in the mesh network segment 202, the Wi-Fi network segment 204, and the Ethernet network segment 212 use standard IP routing configurations to communicate with each other through transport protocols such as the User Datagram Protocol (UDP) or the Transmission Control Protocol (TCP). When the devices in the mesh network segment 202, the Wi-Fi network segment 204 and/or the Ethernet network segment 212 are provisioned as part of a Weave network, a fabric network, or a CHIP fabric network, the devices can communicate messages over those same UDP and/or TCP transports.

Tunneled Routing

A network tunnel (e.g., the secure tunnel 114) provides for the movement of data from one network to another across a foreign, and often untrusted, network. A network tunnel coupled with Internet Protocol-level routing can be used to form a virtual private network (VPN) with which a private network is extended across another, usually public, network such as the Internet or the access network 108. An access router that includes a functional combination of the network tunnel, IP routing, and the VPN can be delivered as a virtual service. An access router can run in a variety of contexts, including on dedicated or multi-function devices. The access router virtually connects two network segments across an access network, extending the application network (e.g., a fabric network, a Weave network, a CHIP fabric network). Tunneled connections between access routers are encrypted to provide security and are mutually authenticated, for example, by certificates and/or key exchanges to authenticate that the network segments are segments within the same provisioned application network.

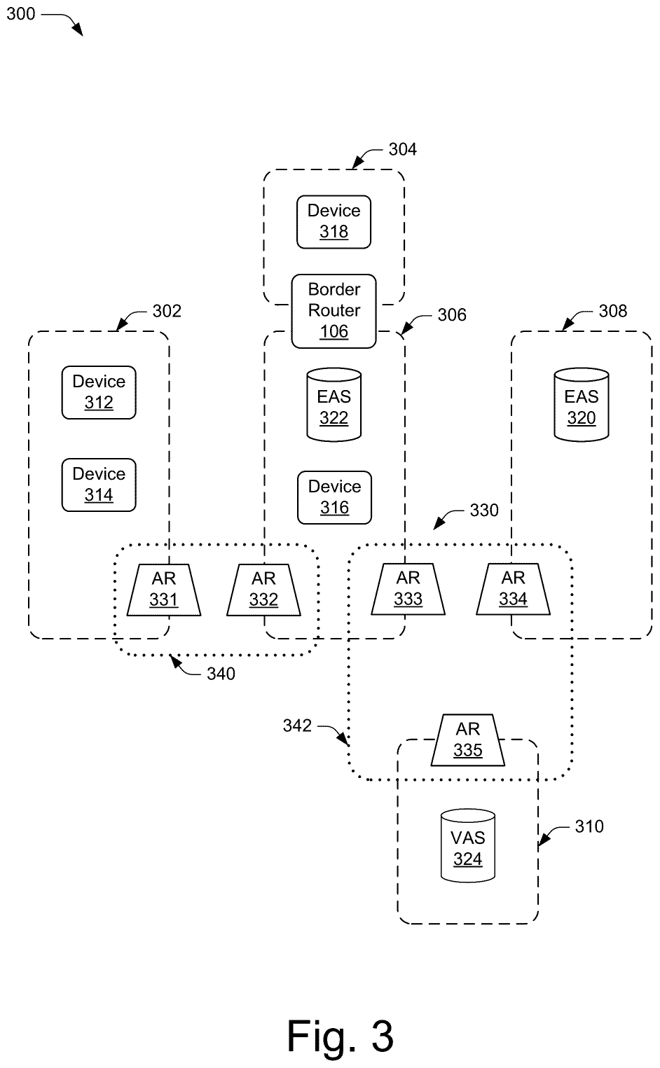

FIG. 3 illustrates an example fabric network 300 with which aspects of adapting IPv4-only devices for IPv6 communication can be implemented. The fabric network 300 is a logical network that includes fabric network segments 302, 204, 306, 308, and 310. Fabric network segment 302 includes devices 312 and 314, that may be, for example, wireless network devices 102, routers 206, end devices 208, Wi-Fi devices 210 and/or Ethernet devices 214. Fabric network segment 304 includes device 318 and the border router 106. The border router 106 connects the fabric network segment 304 to a Thread fabric network segment 306 that includes the border router 106, the device 316, and an on-premises EAS 322. The fabric network segment 308 includes on off-premises EAS 320 and the fabric network segment 310 includes a VAS 324.

Access routers 330 include the access routers 331, 332, 333, 334, and 335 (illustrated as “AR” for clarity of illustration). Each access router 330 runs as a service on any suitable device in its respective fabric network segment. For example, the access router 331 runs as a service on the device 314, the access routers 332 and 333 run as a service on the EAS 322, and so forth. The access routers 331 and 332 logically and virtually connect the fabric network segments 302 and 306 across an access network 340. The access routers 333, 334, and 335 logically and virtually connect the fabric network segments 306, 308, and 310 across an access network 342. Alternatively, the access networks 340 and 342 may be the same, single access network. The connection of fabric network segments with the access routers 300 enables the VAS of a third-party vendor to connect to that vendor's devices using the same tunneled network used for other fabric network applications. Additionally, devices operating in the fabric network with limited resources (e.g., memory, computational resources, and/or power) can use a single networking stack for communication in the primary vendor's ecosystem and for vendor-specific communications.

The fabric network 300 uses an Internet Protocol version 6 (IPv6) unique-local address (ULA) addressing model. Subnet identifiers for each fabric network segment are assigned within the ULA addressing model. Well-known anycast addresses are assigned for services in the fabric network.

Fabric Network Stack

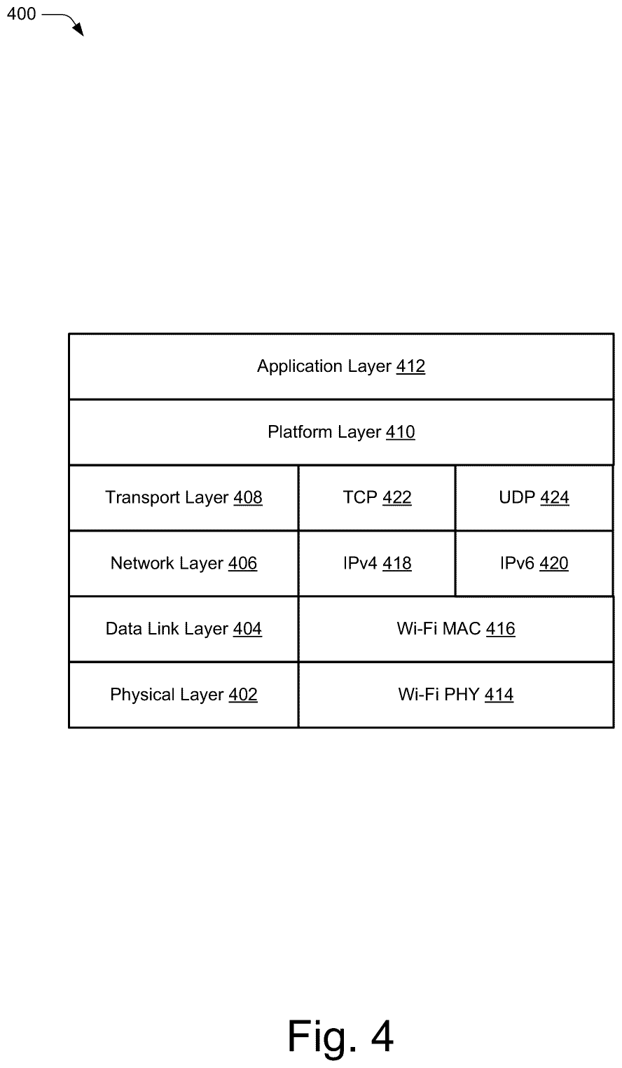

FIG. 4 illustrates an example block diagram of a fabric network (e.g., a Weave network, a Connected Home over IP (CHIP)) network) stack model 400 that characterizes a communication system for the example environments 100, 200, and 300 in which various embodiments of adapting IPv4-only devices for IPv6 communication can be implemented. In one aspect, the fabric network stack model includes six layers: a physical layer 402, a data link layer 404, a network layer 406, a transport layer 408, a platform layer 410, and an application layer 412. Generally, each layer in the fabric network stack model 400 serves the layer above it and is served by the layer below it. In at least some aspects, a higher layer is agnostic to technologies used in lower layers. For example, the platform layer 410 is agnostic to the network type used in the network layer 406.

The physical layer 402 provides hardware specifications for devices that communicate with each other. As such, the physical layer 402 establishes how devices connect to each other, assists in managing how communication resources are shared between devices, and the like. For example, the physical layer 402 of the fabric network stack model 400 includes a Wi-Fi Physical (PHY) layer 414 to transmit and receive Wi-Fi communications in the Wi-Fi network segment 204.

The data link layer 404 specifies how data is transferred between devices. Generally, the data link layer 404 provides a way in which data packets being transmitted are encoded and decoded into bits as part of a transmission protocol. For example, the data link layer 404 of the fabric network stack model 400 includes a Wi-Fi Medium Access Control (MAC) layer 416 to specify how data is transferred between devices,

The network layer 406 specifies how the data being transferred to a destination node is routed. The network layer 406 also provides a security protocol that maintains the integrity of the data being transferred. For example, the network layer 406 of IPv4-only devices uses IPv4 at 418 and the network layer 406 of the fabric network stack model 400 uses IPv6 at 420 and a routing protocol, such as Distance Vector Routing, to specify how the data being transferred to a destination node is routed.

The transport layer 408 specifies a transparent transfer of the data from a source node to a destination node. The transport layer 408 also controls how the transparent transfer of the data remains reliable. As such, the transport layer 408 is used to verify that data packets intended to be transferred to the destination node indeed reached the destination node. Example protocols that may be employed in the transport layer 408 include Transmission Control Protocol (TCP) 422 and User Datagram Protocol (UDP) 424.

The platform layer 410 (also known as an application sublayer, an application interface layer, a CHIP layer, and/or an application framework) establishes connections between devices according to the protocol specified within the transport layer 408. The platform layer 410 also translates the data packets into a form that the application layer 412 may use. The application layer 412 supports a software application that may directly interface with the user. As such, the application layer 412 implements protocols defined by the software application. For example, the software application may provide services for an IoT application such as user access to control settings, a device application program such as a thermostat application, a security application, a lighting control application, and the like.

Device Architectures

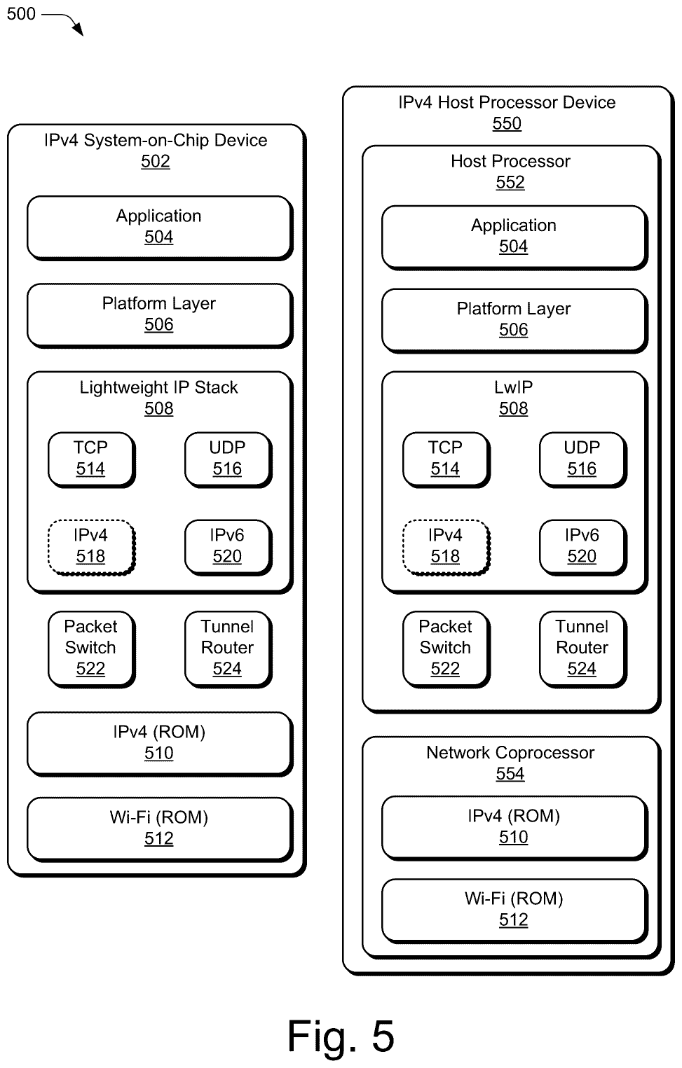

FIG. 5 illustrates example architectures of wireless network devices that can be implemented in accordance with one or more aspects of the techniques described herein. The devices include an IPv4 System-on-Chip (SoC) device 502 or an IPv4 host processor device 550 with a host processor 552 and a network coprocessor (NCP) 554. The IPv4 SoC device 502, the IPv4 host processor device 550, the host processor 552, and the NCP 554 may include additional functions and interfaces that are omitted from FIG. 5 for the sake of illustration clarity, for example, processors, microcontrollers, sensors, radio circuitry (e.g., a Wi-Fi radio, a radio frequency (RF) front end), a power source (e.g., a battery, a line-powered power supply), computer-readable storage media (CRM) (e.g., random-access memory (RAM), static RAM (SRAM), dynamic RAM (DRAM), non-volatile RAM (NVRAM), read-only memory (ROM), or Flash memory), or the like.

The IPv4 SoC device 502 is a connectivity device based on an SoC integrated circuit. The SoC integrated circuit includes both processing resources (e.g., a microcontroller, memory, input/output busses or lines) and communication resources, such as the lower layers of the network stack 400 (e.g., PHY layer 402, data link layer 404, network layer 406), radio circuitry, an RF front end, or the like.

The IPv4 host processor device 550 is based on the host processor 552 and the network coprocessor (NCP) 554. The host processor 552 includes processing resources (e.g., a microcontroller, memory, input/output busses or lines) that includes firmware and/or software that implements upper layers of the fabric network stack model 400. The NCP 554 includes communication resources, such as the lower layers of the network stack 400 (e.g., PHY layer 402, data link layer 404, network layer 406), radio circuitry, an RF front end, or the like. The NCP 554 is connected to the host processor 552 via a serial link (e.g., a Universal Asynchronous Receiver/Transmitter (UART), a Serial Peripheral Interface (SPI), a Secure Digital Input Output (SDIO) interface, or the like). All network activity is dispatched to and/or received from the NCP 554 via the serial link for an application running on the host processor 552.

In one aspect, the IPv4 SoC device 502 includes the application 504, the platform layer 506, and the Lightweight IP (LwIP) network stack 508, the IPv4 layer 418 in ROM (IPv4 (ROM) 510), and the Wi-Fi MAC 416, and the Wi-Fi PHY 414 in ROM (Wi-Fi (ROM) 512). In another aspect, the IPv4 host processor device 550 includes the application 504, the platform layer 506, and the Lightweight IP (LwIP) network stack 508, and the network coprocessor (NCP) 554 includes the IPv4 layer 418 in ROM (IPv4 (ROM) 510), and the Wi-Fi MAC 416, and the Wi-Fi PHY 414 in ROM (Wi-Fi (ROM) 512).

The LwIP stack 508 includes software/firmware that is executable to implement networking protocols of the network layer 406 and the transport layer 408 of the fabric network stack model 400 that are designed to fit into the limited available memory of ROMed IPv4-only devices. The LwIP stack 508 includes a TCP layer 514 (TCP 514) that implements the TCP 422 in the transport layer 408, a UDP layer 516 (UDP 516) that implements the UDP 424 in the transport layer 408, an IPv4 layer 518 (IPv4 518) that implements the IPv4 418 in the network layer 406, and an IPv6 layer 520 (IPv6 520) that implements the IPv6 420 in the network layer 406. The IPv4 layer 518 is illustrated with a dashed line to indicate the IPv4 layer 518 can be implemented to provide interfaces to layers above and below without implementing the full IPv4 functionality itself. The IPv4 layer 518, as discussed below, can interact with the IPv4 (ROM) 510 to use the use the IPv4 implementation in the IPv4 (ROM) 510 to provide IPv4 functionality in the LwIP stack 508).

The IPv4 SoC device 502 and the IPv4 host processor device 550 also include a packet switch 522 and a tunnel router 524. As discussed in greater detail below, the packet switch 522 receives and inspects IP packets (IPv4 and IPv6 packets) from layers above and below and determines a destination for each received packet. For example, based on determining a packet type (IPv4 or IPv6) and the interface over which the packet was received (incoming or outgoing), the packet switch 522 determines which interface in the fabric network stack 400 the packet switch 522 will use to forward the packet. In one aspect, the packet switch 522 and the tunnel router 524 are included in the platform layer 506.

The tunnel router 524 implements the functionality of an access router 330 to provide IPv6 connectivity for an IPv4 SoC device 502 or an IPv4 host processor device 550. The tunnel router 524 acts as the proximal end of an access router pair to provide an IPv6-over-IPv4 (6-over-4) tunnel to provide IPv6 access routes for IPv6 traffic to one or more distal access routers in a fabric network.

Tunneled Routing for IPv4-Only Devices

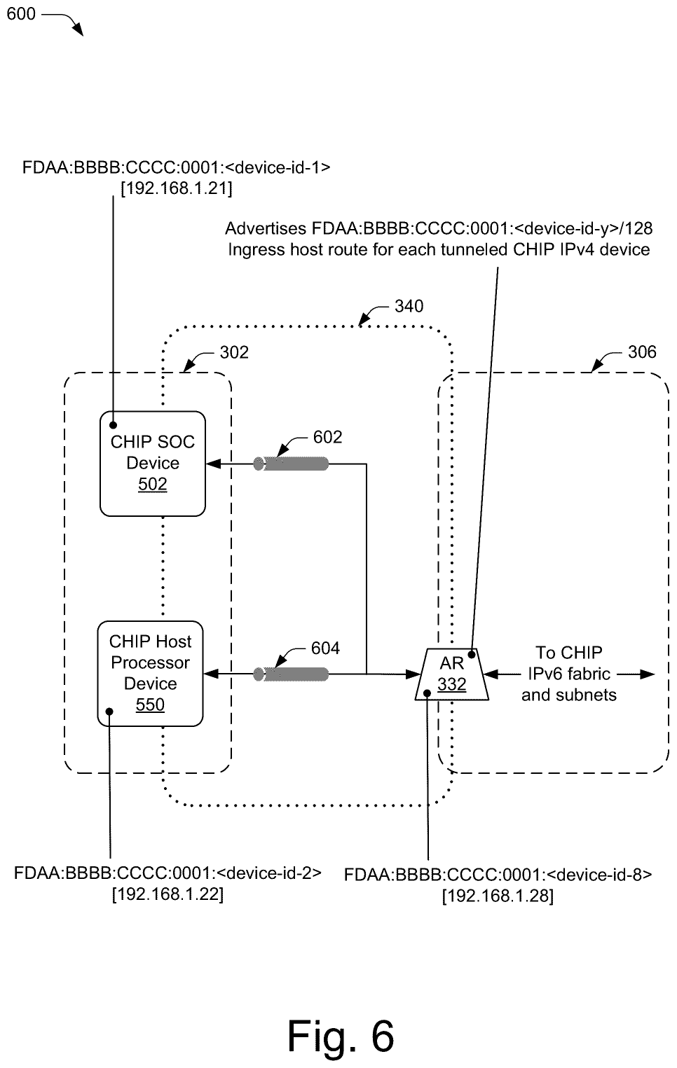

FIG. 6 illustrates an example of tunneling in a fabric network 600 with which aspects of adapting IPv4-only devices for IPv6 communication can be implemented. An IPv4 SoC device 502 or an IPv4 host processor device 550 can be provisioned with one or more IPv4 addresses for distal access routers 330 or use a dynamic discovery protocol to obtain IPv4 addresses of distal routers 330. With the address of a distal access router 330, the IPv4 SoC device 502 or a IPv4 host processor device 550 (e.g., using the tunnel router 524) can form a tunnel with the distal router and create an access route for that distal router.

For example, the IPv4 SoC device 502 in the fabric network segment 302 establishes a secured IPv6-over-IPv4 tunnel 602 with the access router 332 in the fabric network segment 306 over the access network 340. The IPv4 host processor device 550 in the fabric network segment 302 establishes a secured IPv6-over-IPv4 tunnel 604 with the access router 332 in the fabric network segment 306 over the access network 340. The tunnel router 524 in the IPv4 SoC device 502 and the IPv4 host processor device 550 advertises a network route, in this example advertising FDAA:BBBB:CCCC/56 as the network route (the ULA routing prefix), for the IPv6 fabric network. In this example, the access router 332 resides on a fabric subnet 0x0001 and has an IPv4 address: 192.168.1.28 and an IPv6 address: FDAA:BBBB:CCCC:0001:<device-id-8>, however, any suitable values for the ULA routing prefix, fabric subnet and IP addresses can be used. The IPv4 SoC device 502 has an IPv4 address: 192.168.1.21 and an IPv6 address: FDAA:BBBB:CCCC:0001:<device-id-1> and the IPv4 host processor device 550 has an IPv4 address: 192.168.1.22 and an IPv6 address: FDAA:BBBB:CCCC:0001:<device-id-2>. The access router advertises an ingress host route for the tunneled IPv4 devices: FDAA:BBBB:CCCC:0001:<device-id-y>/128, where “<device-id-y>” is replaced by <device-id-1> for the tunnel to the IPv4 SoC device 502 or is replaced by <device-id-2> for the tunnel to the IPv4 host processor device 550.

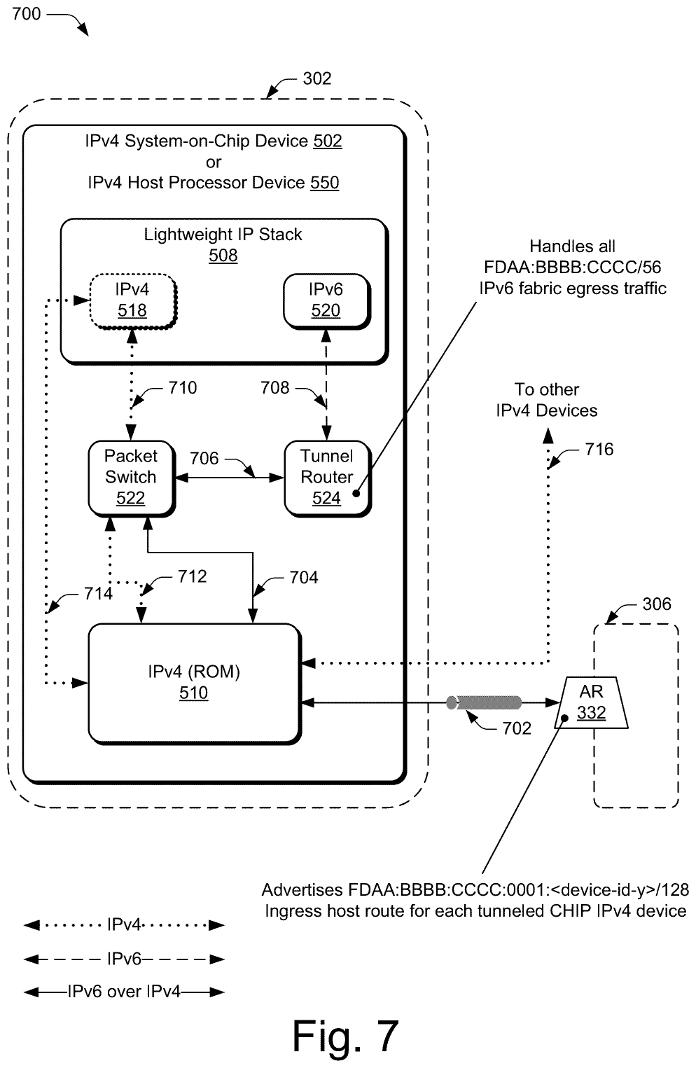

FIG. 7 illustrates example operations of a Lightweight Internet Protocol (LwIP) network stack, a packet switch, and a tunnel router based on the tunnels and addressing described with respect to FIG. 6 with which aspects of adapting IPv4-only devices for IPv6 communication can be implemented. In FIG. 7 IPv4 traffic is illustrated with dotted lines, IPv6 traffic is illustrated with dashed lines, and IPv6-over-IPv4 tunneled traffic is illustrated by solid lines. The operations described with respect to the LwIP stack 508, the packet switch 522, the tunnel router 524, and the IPv4 (ROM) 510 apply to both the IPv4 SoC device 502 and the IPv4 host processor device 550. IP traffic flows through the PHY and MAC layers are omitted in FIG. 7 for the sake of illustration clarity.

As described above, with reference to FIG. 6, an IPv6-over-IPv4 tunnel 702 is established between an IPv4-only device (e.g., the IPv4 SoC device 502 or the IPv4 host processor device 550) and the access router 332. The tunnel router 524 advertises an access route (e.g., FDAA:BBBB:CCCC/56) for all IPv6 egress traffic from the IPv4-only device to the fabric network 300. As described above with respect to FIG. 6, the access router 332 advertises an ingress host route for the tunneled IPv4 devices: FDAA:BBBB:CCCC:0001:<device-id-y>/128.

IPv6 fabric ingress traffic (data packets) from other fabric devices is routed by the access router 332 through the to the IPv6-over-IPv4 tunnel 702 to the IPv4 (ROM) 510 that forwards, at 704, the ingress traffic to the packet switch 522. The packet switch 522 determines that the ingress traffic received from the IPv4 (ROM) 510 is IPv6-over-IPv4 tunneled traffic and forwards the ingress traffic to the tunnel router 524. The tunnel router 524 determines if the IPv6 traffic matches the advertised access route for the tunnel 702 (e.g., FDAA:BBBB:CCCC/56). If the traffic matches the advertised access route, the tunnel forwards, at 708, the IPv6 traffic to the IPv6 layer 520 to be forwarded to the upper layers of the fabric network stack 400 (not shown). If the traffic does not match the advertised access route, the tunnel router 524 drops the IPv6 traffic. In an alternative aspect, IPv4 protocol may be implemented by the IPv4 layer 518, in which case the ingress IPv6 fabric ingress traffic (data packets) from other fabric devices is routed by the access router 332 through the to the IPv6-over-IPv4 tunnel 702 to the IPv4 layer 518 (not illustrated) that forwards the ingress traffic to the packet switch 522 for processing as described above.

IPv6 fabric egress traffic from the IPv4-only device follows the reverse of the path described for ingress traffic. The IPv6 layer 520 forwards the egress traffic (e.g., egress traffic for the prefix FDAA:BBBB:CCCC/56) to the tunnel router 524 that forwards the egress traffic in an IPv6-over-IPv4 tunnel, at 706, to the packet switch 522 that in turn forwards, at 710, the egress traffic to the IPv4 (ROM) layer 510 to be forwarded to the access router 332 that forwards the tunneled IPv6 egress traffic across the IPv6 fabric network. In an alternative aspect, the packet switch 522 forwards the tunneled IPv6 egress traffic to the IPv4 layer 518 (not illustrated) that forwards the tunneled IPv6 egress traffic to the IPv4 (ROM) layer 510, using an entry point (e.g., “cut point” or service access point) of the IPv4 (ROM) layer 510, for transmission over the tunnel 702.

The IPv4-only device also uses the LwIP stack 508 for IPv4 traffic. For IPv4 egress traffic, traffic from upper layers of the network stack is passed down to the IPv4 layer 518. In one aspect, the IPv4 layer 518 uses the IPv4 (ROM) layer to perform some or all of the IPv4 protocol operations. The IPv4 layer 518 forwards, at 710 and 712, the IPv4 egress traffic via the packet switch 522 to the IPv4 (ROM) layer to transmit the IPv4 egress traffic to other IPv4 devices at 716. Alternatively, the IPv4 layer 518 forwards, at 714, the IPv4 egress traffic directly to an entry point of the IPv4 (ROM) layer to transmit the IPv4 egress traffic.

For IPv4 ingress traffic, traffic from the PHY and MAC layers of the network stack is passed up to the IPv4 layer 518. In one aspect, the IPv4 layer 518 uses the IPv4 (ROM) layer to perform some or all of the IPv4 protocol operations. The IPv4 layer 518 receives, at 712 and 710, the IPv4 ingress traffic via the packet switch 522 from the IPv4 (ROM) layer 510. Alternatively, the IPv4 (ROM) layer 510 forwards, at 714, the IPv4 ingress traffic directly to IPv4 layer 518.

In another alternative, the IPv4 layer 518 bypasses the IPv4 (ROM) layer 510 for ingress and egress traffic. In this alternative, the IPv4 layer 518 fully implements the IPv4 protocol operations and interfaces with the data link layer 404 for IPv4 ingress and egress traffic.

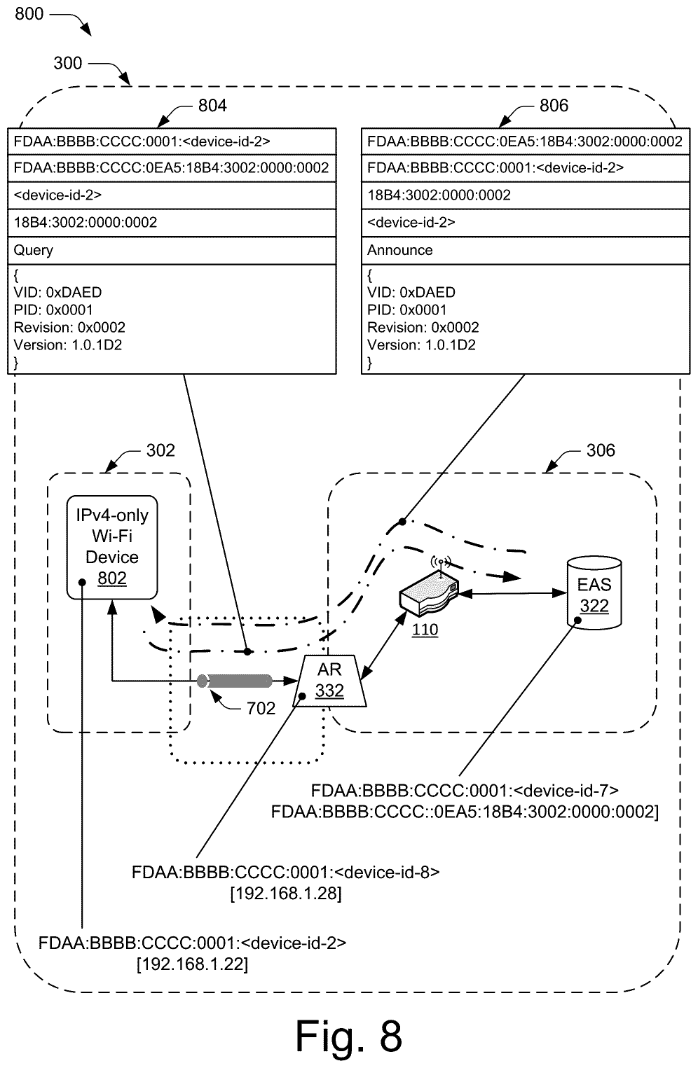

FIG. 8 illustrates example message routing 800 between an IPv4-only device and an in-premises EAS in accordance with aspects of adapting IPv4-only devices for IPv6 communication. An IPv4-only Wi-Fi device 802 and the in-premises EAS 322 and reside on different fabric network subnets 302 and 306, respectively.

In this example, messages are illustrated by two protocol command messages, an announce command message from an EAS sent to a device in the fabric network 300 (e.g., an image announce sent to a device indicating that the EAS has a software update for the device) and a query command message from a device to an EAS (e.g., an image query sent by a device to an EAS to ask if a newer version of software is available for the device). Although the messages are illustrated as announce and query messages, other protocol commands use the same message and address formats, for example, messages that include announce and query commands related to file downloads, time of day and time synchronization, file uploads, vending of operational certificates for authentication, device and resource directories or registries, data management proxies (e.g., for commands, state, and/or settings), or the like.

The example announce and query messages illustrated in FIG. 8 each include an IPv6 source address, an IPv6 destination address, a source interface identifier (IID), a destination IID, a protocol command identifier (“Announce” or “Query”), and a parameters field that includes parameters associated with the protocol command, for example a vendor identifier (VID), a product identifier (PID), a revision, and a current software version. In this example, the following values are used; however, any suitable values can be used. The ULA routing prefix for the fabric network is: FDAA:BBBB:CCCC/56. An ecosystem administrative service (EAS) subnet is statically assigned the value: 0x0EA5. A primary Wi-Fi subnet (fabric subnet 302) is administratively assigned the value: 0x0001. A well-known anycast interface identifier (IID) for an EAS service (e.g., a software update service) is assigned the value: 18B4:3002:0000:0002. The IPv4-only Wi-Fi Device 802 is assigned an IID: <device-id-2>, a vendor identifier (VID): 0xDAED, a product identifier (PID): 0x0001, a revision: 0x0002, and a current software version: 1.0.1D2.

The in-premises EAS 322 and the IPv4-only Wi-Fi device 802 are connected to an in-premises Wi-Fi subnet provided by the access point 110. The access point 110 provides connectivity to the access network 108 which is not illustrated in FIG. 8 for the sake of illustration clarity.

To send a query message 804 (e.g., an unsolicited image query for a software update), the IPv4-only Wi-Fi device 802 forms the well-known anycast destination address including the ULA routing prefix (FDAA:BBBB:CCCC), the well-known EAS Subnet (0x0EA5), and well-known Software Update IID (18B4:3002:0000:0002). When the query message 804 is sent, the access router functionality of the tunnel router 524 in the IPv4-only Wi-Fi device 314 forwards the query message 804 using the tunnel 702 to reach the distal access router 332 that forwards the query message 804 to the EAS 322 via the Wi-Fi access point 110.

To send an announce message 806 (e.g., an unsolicited image announce for a software update) to the IPv4-only Wi-Fi device 802, the EAS 322 forms the device address including the ULA routing prefix (FDAA:BBBB:CCCC), the primary Wi-Fi subnet (0x0001), and the device IID for the IPv4-only Wi-Fi device 802 (<device-id-2>). The EAS 322 may lookup the primary Wi-Fi subnet and device IID in its registry or directory. The FDAA:BBBB:CCCC:0001:<device-id-2>/128 host route advertised by the access router 322 and received by the EAS 322 will resolve the Wi-Fi MAC address to which the message should be addressed at the link layer and forward the announce message via the tunnel 702 to the IPv4-only Wi-Fi device 802.

Example Method

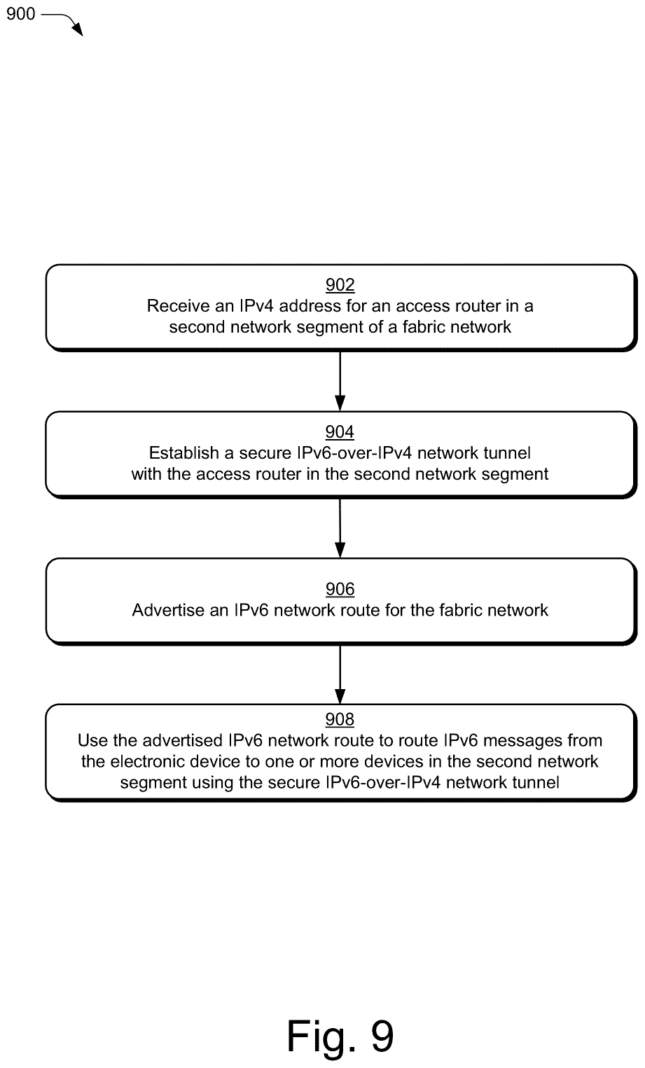

Example method 900 is described with reference to FIG. 9 in accordance with one or more aspects of adapting IPv4-only devices for IPv6 communication. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the method blocks are described is not intended to be construed as a limitation, and any number of the described method blocks can be combined in any order or skipped to implement a method or an alternate method.

FIG. 9 illustrates example method(s) 900 of adapting IPv4-only devices for IPv6 communication as generally related to using secure tunnels to an access router in a fabric network for IPv6 communication. At block 902, a tunnel router in an IPv4-only electronic device in a first network segment of a fabric network receives an IPv4 address for an access router in a second network segment of the fabric network. For example, a tunnel router (e.g., the tunnel router 524) in an IPv4-only electronic device (e.g., the IPv4 SoC device 502 or the IPv4 host processor device 550) in a first network segment (e.g., the fabric network segment 302) of a fabric network (e.g., the fabric network 300) receives an IPv4 address for an access router (e.g., the access router 332) in a second network segment (e.g., the fabric network segment 306) of the fabric network.

At block 904, the tunnel router establishes a secure IPv6-over-IPv4 network tunnel with the access router in the second network segment. For example, the tunnel router establishes a secure IPv6-over-IPv4 network tunnel (e.g., the IPv6-over-IPv4 tunnel 702) with the access router in the second network segment.

At block 906, the tunnel router advertises an IPv6 network route for the fabric network. For example, the tunnel router advertises an IPv6 network route for the fabric network that includes an IPv6 ULA routing prefix of the fabric network.

At block 908, using the advertised IPv6 network route, the tunnel router routes IPv6 messages from the electronic device to one or more devices in the second network segment using the secure IPv6-over-IPv4 network tunnel. For example, using the advertised IPv6 network route, the tunnel router routes IPv6 messages (e.g., messages 804 and 806) from the electronic device to one or more devices in the second network segment using the secure IPv6-over-IPv4 network tunnel.

Example Environments and Devices

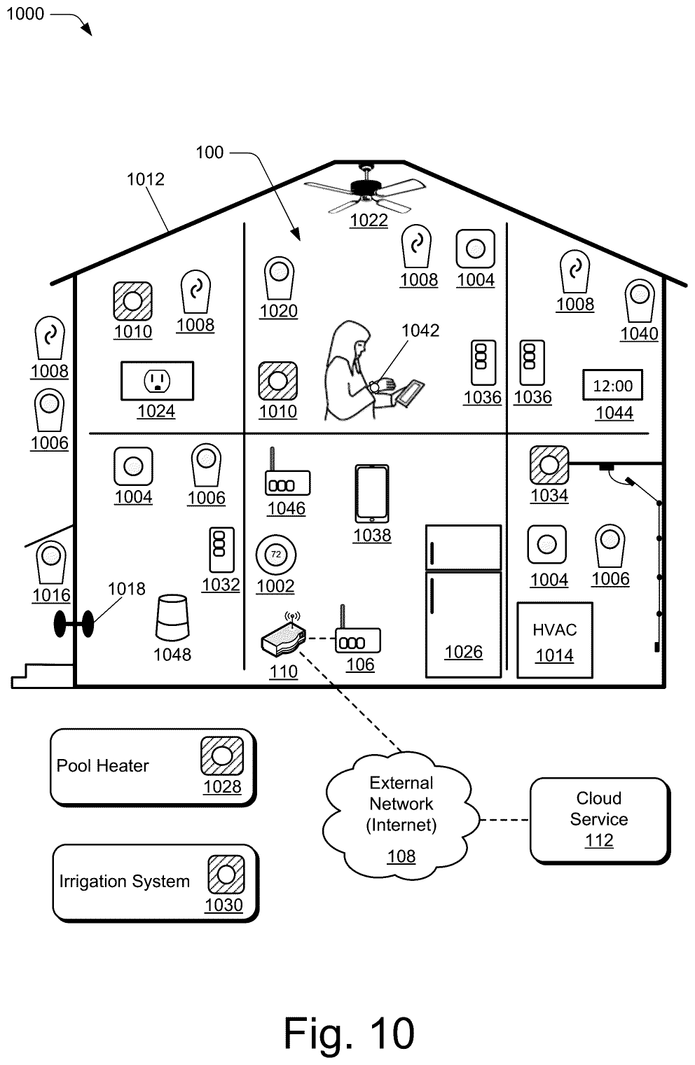

FIG. 10 illustrates an example environment 1000 in which a fabric, Weave, or CHIP network 100, 200, and/or 300 and aspects of adapting IPv4-only devices for IPv6 communication can be implemented. Generally, the environment 1000 includes the home area network (HAN) 200 implemented as part of a home or other type of structure with any number of wireless network devices that are configured for communication in a wireless network. For example, the wireless network devices can include a thermostat 1002, hazard detectors 1004 (e.g., for smoke and/or carbon monoxide), cameras 1006 (e.g., indoor and outdoor), lighting units 1008 (e.g., indoor and outdoor), and any other types of wireless network devices 1010 that are implemented inside and/or outside of a structure 1012 (e.g., in a home environment). In this example, the wireless network devices can also include any of the previously described devices, such as a border router 106, as well as any of the devices implemented as a router device 206, and/or as an end device 208.

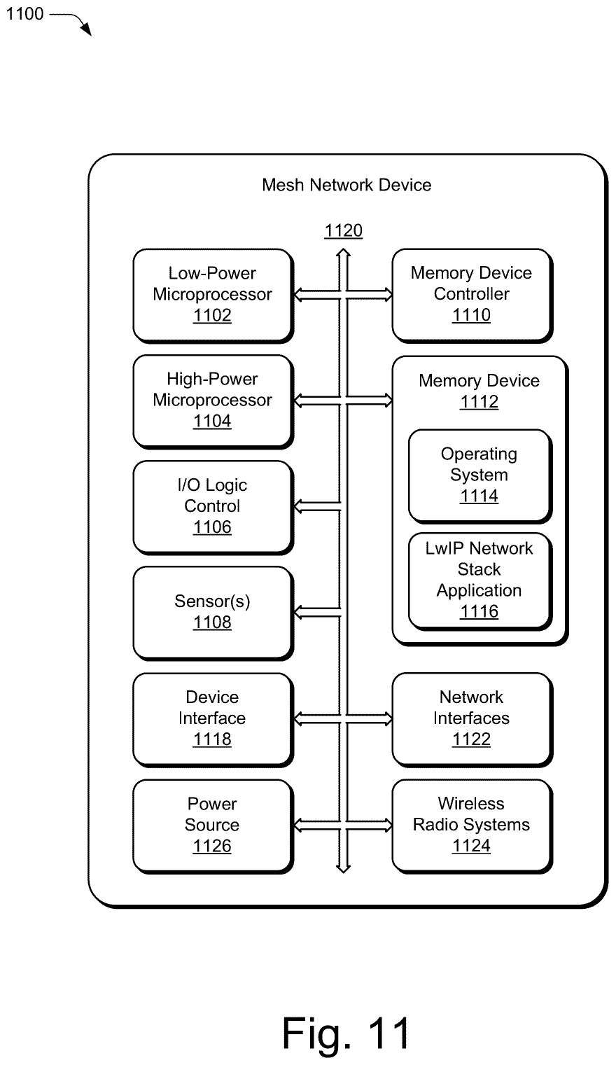

In the environment 1000, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 11.

In implementations, the thermostat 1002 may include a Nest® Learning Thermostat that detects ambient climate characteristics (e.g., temperature and/or humidity) and controls a HVAC system 1014 in the home environment. The learning thermostat 1002 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 1004 can be implemented to detect the presence of a hazardous substance or a substance indicative of a hazardous substance (e.g., smoke, fire, or carbon monoxide). In examples of wireless interconnection, a hazard detector 1004 may detect the presence of smoke, indicating a fire in the structure, in which case the hazard detector that first detects the smoke can broadcast a low-power wake-up signal to all of the connected wireless network devices. The other hazard detectors 1004 can then receive the broadcast wake-up signal and initiate a high-power state for hazard detection and to receive wireless communications of alert messages. Further, the lighting units 1008 can receive the broadcast wake-up signal and activate in the region of the detected hazard to illuminate and identify the problem area. In another example, the lighting units 1008 may activate in one illumination color to indicate a problem area or region in the structure, such as for a detected fire or break-in, and activate in a different illumination color to indicate safe regions and/or escape routes out of the structure.

In various configurations, the wireless network devices 1010 can include an entryway interface device 1016 that functions in coordination with a network-connected door lock system 1018, and that detects and responds to a person's approach to or departure from a location, such as an outer door of the structure 1012. The entryway interface device 1016 can interact with the other wireless network devices based on whether someone has approached or entered the smart-home environment. An entryway interface device 1016 can control doorbell functionality, announce the approach or departure of a person via audio or visual means, and control settings on a security system, such as to activate or deactivate the security system when occupants come and go. The wireless network devices 1010 can also include other sensors and detectors, such as to detect ambient lighting conditions, detect room-occupancy states (e.g., with an occupancy sensor 1020), and control a power and/or dim state of one or more lights. In some instances, the sensors and/or detectors may also control a power state or speed of a fan, such as a ceiling fan 1022. Further, the sensors and/or detectors may detect occupancy in a room or enclosure and control the supply of power to electrical outlets or devices 1024, such as if a room or the structure is unoccupied.

The wireless network devices 1010 may also include connected appliances and/or controlled systems 1026, such as refrigerators, stoves and ovens, washers, dryers, air conditioners, pool heaters 1028, irrigation systems 1030, security systems 1032, and so forth, as well as other electronic and computing devices, such as televisions, entertainment systems, computers, intercom systems, garage-door openers 1034, ceiling fans 1022, control panels 1036, and the like. When plugged in, an appliance, device, or system can announce itself to the home area network as described above and can be automatically integrated with the controls and devices of the home area network, such as in the home. It should be noted that the wireless network devices 1010 may include devices physically located outside of the structure, but within wireless communication range, such as a device controlling a swimming pool heater 1028 or an irrigation system 1030.

As described above, the HAN 200 includes a border router 106 that interfaces for communication with an external network, outside the HAN 200. The border router 106 connects to an access point 110, which connects to the access network 108, such as the Internet. A cloud service 112, which is connected via the access network 108, provides services related to and/or using the devices within the HAN 200. By way of example, the cloud service 112 can include applications for connecting end user devices 1038, such as smartphones, tablets, and the like, to devices in the home area network, processing and presenting data acquired in the HAN 200 to end users, linking devices in one or more HANs 200 to user accounts of the cloud service 112, provisioning and updating devices in the HAN 200, and so forth. For example, a user can control the thermostat 1002 and other wireless network devices in the home environment using a network-connected computer or portable device, such as a mobile phone or tablet device. Further, the wireless network devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, etc.).

Any of the wireless network devices in the HAN 200 can serve as low-power and communication nodes to create the HAN 200 in the home environment. Individual low-power nodes of the network can regularly send out messages regarding what they are sensing, and the other low-powered nodes in the environment—in addition to sending out their own messages—can repeat the messages, thereby communicating the messages from node to node (i.e., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 1040 detects that the room is dark and when the occupancy sensor 1020 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (i.e., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 1008 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 1008 that lead to a safe exit. The light units 1008 may also be turned-on to indicate the direction along an exit route that a person should travel to safely exit the structure.

The various wireless network devices may also be implemented to integrate and communicate with wearable computing devices 1042, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 1010 may also include a network-connected alarm clock 1044 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 1002 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 1002 so as to pre-heat or cool the environment to a desired setting and turning-on or turning-off the lights 1008.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 1000 may include one or more wireless network devices that function as a hub 1046. The hub 1046 may be a general-purpose home automation hub, or an application-specific hub, such as a security hub, an energy management hub, an HVAC hub, and so forth. The functionality of a hub 1046 may also be integrated into any wireless network device, such as a network-connected thermostat device or the border router 106. Hosting functionality on the hub 1046 in the structure 1012 can improve reliability when the user's internet connection is unreliable, can reduce latency of operations that would normally have to connect to the cloud service 112, and can satisfy system and regulatory constraints around local access between wireless network devices.

Additionally, the example environment 1000 includes a network-connected—speaker 1048. The network-connected speaker 1048 provides voice assistant services that include providing voice control of network-connected devices. The functions of the hub 1046 may be hosted in the network-connected speaker 1048. The network-connected speaker 1048 can be configured to communicate via the wireless mesh network 202, the Wi-Fi network 204, or both.

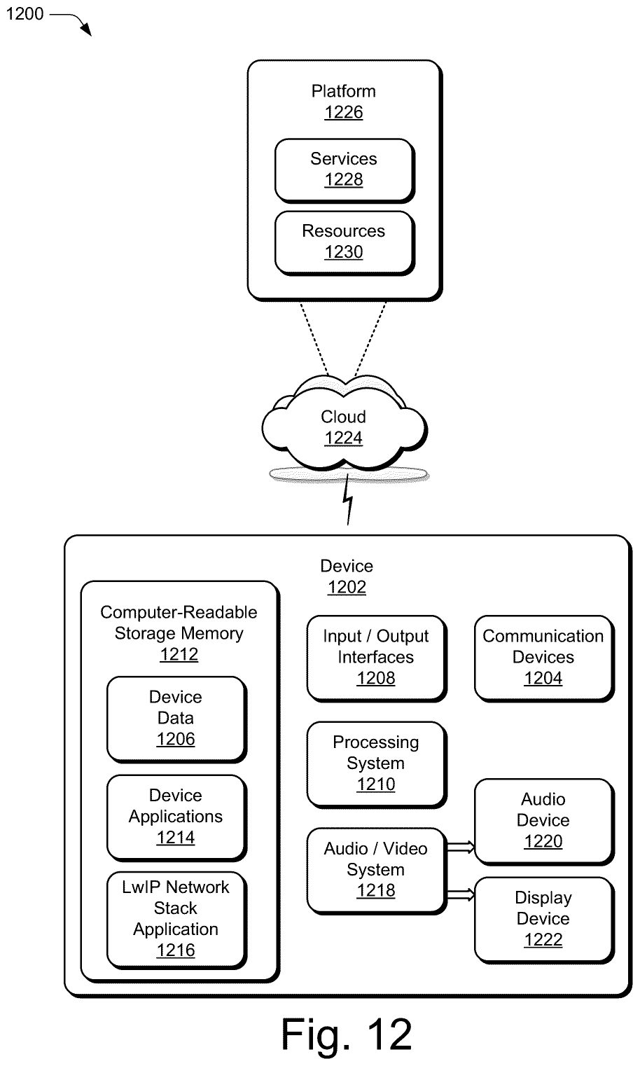

FIG. 11 illustrates an example wireless network device 1100 that can be implemented as any of the wireless network devices in a home area network (fabric network, Weave network, CHIP fabric network) in accordance with one or more aspects of adapting IPv4-only devices for IPv6 communication as described herein. The device 1100 can be integrated with electronic circuitry, microprocessors, memory, input output (I/O) logic control, communication interfaces and components, as well as other hardware, firmware, and/or software to implement the device in a home area network. Further, the wireless network device 1100 can be implemented with various components, such as with any number and combination of different components as further described with reference to the example device shown in FIG. 12.

In this example, the wireless network device 1100 includes a low-power microprocessor 1102 and a high-power microprocessor 1104 (e.g., microcontrollers or digital signal processors) that process executable instructions. The device also includes an input-output (I/O) logic control 1106 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 1102 and the high-power microprocessor 604 can also support one or more different device functionalities of the device. For example, the high-power microprocessor 1104 may execute computationally intensive operations, whereas the low-power microprocessor 1102 may manage less-complex processes such as detecting a hazard or temperature from one or more sensors 1108. The low-power processor 1102 may also wake or initialize the high-power processor 1104 for computationally intensive processes.

The one or more sensors 1108 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 1108 may include any one or a combination of temperature sensors, humidity sensors, hazard-related sensors, other environmental sensors, accelerometers, microphones, optical sensors up to and including cameras (e.g., charged coupled-device or video cameras, active or passive radiation sensors, GPS receivers, and radio frequency identification detectors. In implementations, the wireless network device 1100 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The wireless network device 1100 includes a memory device controller 1110 and a memory device 1112, such as any type of a nonvolatile memory and/or other suitable electronic data storage device. The wireless network device 1100 can also include various firmware and/or software, such as an operating system 1114 that is maintained as computer executable instructions by the memory and executed by a microprocessor. The device software may also include a lightweight IP network stack application 1116 that implements aspects of the LwIP IP stack 508, the packet switch 522, and/or the tunnel router 524 for adapting IPv4-only devices for IPv6 communication. The wireless network device 1100 also includes a device interface 1118 to interface with another device or peripheral component and includes an integrated data bus 1120 that couples the various components of the wireless network device for data communication between the components. The data bus in the wireless network device may also be implemented as any one or a combination of different bus structures and/or bus architectures.

The device interface 1118 may receive input from a user and/or provide information to the user (e.g., as a user interface), and a received input can be used to determine a setting. The device interface 1118 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 1118 may also receive inputs from any number of peripherals, such as buttons, a keypad, a switch, a microphone, and an imager (e.g., a camera device).

The wireless network device 1100 can include network interfaces 1122, such as a home area network interface for communication with other wireless network devices in a home area network, and an external network interface for network communication, such as via the Internet. The wireless network device 1100 also includes wireless radio systems 1124 for wireless communication with other wireless network devices via the home area network interface and for multiple, different wireless communications systems. The wireless radio systems 1124 may include Wi-Fi, Bluetooth™, Mobile Broadband, BLE, and/or point-to-point IEEE 802.15.4. Each of the different radio systems can include a radio device, antenna, and chipset that is implemented for a particular wireless communications technology. The wireless network device 1100 also includes a power source 1126, such as a battery and/or to connect the device to line voltage. An AC power source may also be used to charge the battery of the device.

FIG. 12 illustrates an example system 1200 that includes an example device 1202, which can be implemented as any of the wireless network devices that implement aspects of adapting IPv4-only devices for IPv6 communication as described with reference to the previous FIGS. 1-11. The example device 1202 may be any type of computing device, client device, mobile phone, tablet, communication, entertainment, gaming, media playback, and/or other type of device. Further, the example device 1202 may be implemented as any other type of wireless network device that is configured for communication on a home area network, such as a thermostat, hazard detector, camera, light unit, commissioning device, router, border router, joiner router, joining device, end device, leader, access point, and/or other wireless network devices.

The device 1202 includes communication devices 1204 that enable wired and/or wireless communication of device data 1206, such as data that is communicated between the devices in a home area network, data that is being received, data scheduled for broadcast, data packets of the data, data that is synched between the devices, etc. The device data can include any type of communication data, as well as audio, video, and/or image data that is generated by applications executing on the device. The communication devices 1204 can also include transceivers for cellular phone communication and/or for network data communication.

The device 1202 also includes input/output (I/O) interfaces 1208, such as data network interfaces that provide connection and/or communication links between the device, data networks (e.g., a home area network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 1202 includes a processing system 1210 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 1202 may further include any type of a system bus or other data and command transfer system that couples the various components within the device. A system bus can include any one or combination of different bus structures and architectures, as well as control and data lines.

The device 1202 also includes computer-readable storage memory 1212, such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 1212 provides storage of the device data 1206 and various device applications 1214, such as an operating system that is maintained as a software application with the computer-readable storage memory and executed by the processing system 1210. The device applications may also include a device manager, such as any form of a control application, software application, signal processing and control module, code that is native to a particular device, a hardware abstraction layer for a particular device, and so on. In this example, the device applications also include a lightweight IP network stack application 1216 that implements the LwIP network stack 508, the packet switch 522, and/or the tunnel router 524 in accordance with aspects of adapting IPv4-only devices for IPv6 communication, such as when the example device 1202 is implemented as any of the wireless network devices described herein.

The device 1202 also includes an audio and/or video system 1218 that generates audio data for an audio device 1220 and/or generates display data for a display device 1222. The audio device and/or the display device include any devices that process, display, and/or otherwise render audio, video, display, and/or image data, such as the image content of a digital photo. In implementations, the audio device and/or the display device are integrated components of the example device 1202. Alternatively, the audio device and/or the display device are external, peripheral components to the example device. In aspects, at least part of the techniques described for adapting IPv4-only devices for IPv6 communication may be implemented in a distributed system, such as over a “cloud” 1224 in a platform 1226. The cloud 1224 includes and/or is representative of the platform 1226 for services 1228 and/or resources 1230.

The platform 1226 abstracts underlying functionality of hardware, such as server devices (e.g., included in the services 1228) and/or software resources (e.g., included as the resources 1230), and connects the example device 1202 with other devices, servers, etc. The resources 1230 may also include applications and/or data that can be utilized while computer processing is executed on servers that are remote from the example device 1202. Additionally, the services 1228 and/or the resources 1230 may facilitate subscriber network services, such as over the Internet, a cellular network, or Wi-Fi network. The platform 1226 may also serve to abstract and scale resources to service a demand for the resources 1230 that are implemented via the platform, such as in an interconnected device aspect with functionality distributed throughout the system 900. For example, the functionality may be implemented in part at the example device 1202 as well as via the platform 1226 that abstracts the functionality of the cloud 1224.

In the following some examples are described: Example 1: A method of communicating Internet Protocol version 6, IPv6, traffic using a lightweight IP, LwIP, network stack and a tunnel router, by an electronic device in a first network segment of a fabric network, the method comprising:
receiving an Internet Protocol version 4, IPv4, address for an access router in a second network segment of the fabric network;
establishing a secure IPv6-over-IPv4 network tunnel with the access router in the second network segment;
advertising an IPv6 network route for the fabric network; and
using the advertised IPv6 network route, routing IPv6 messages from the electronic device to one or more devices in the second network segment using the secure IPv6-over-IPv4 network tunnel.

Example 2: The method of example 1, further comprising:
receiving an IP packet from a Medium Access Control, MAC, layer;
determining that the IP packet is an IPv6 packet; and
based on the determining that the IP packet is an IPv6 packet, sending the IP packet to the tunnel router.

Example 3: The method of example 2, further comprising:
determining, by the tunnel router, that the IPv6 packet matches the advertised IPv6 network route; and
sending the IPv6 packet to an IPv6 network layer, the sending being effective to forward a payload of the IPv6 packet to an application at an application layer in the electronic device.

Example 4: The method of example 2, further comprising:
determining, by the tunnel router, that the IPv6 packet does not match the advertised IPv6 network route; and
dropping the IPv6 packet.

Example 5: The method of example 1, further comprising;
receiving an IP packet from a MAC layer;
determining that the IP packet is an IPv4 packet; and
based on the determining that the IP packet is an IPv4 packet, sending the IPv4 packet to an IPv4 network layer, the sending being effective to forward a payload of the IPv4 packet to an application at an application layer in the electronic device.

Example 6: The method of example 5, wherein the IPv4 network layer is implemented at least in part by an IPv4 network layer stored in Read-Only Memory, ROM, of the electronic device.

Example 7: The method of example 5, wherein the LwIP network stack includes at least part of the IPv4 network layer, wherein a first portion of the IPv4 network layer is implemented by a first IPv4 network layer stored in ROM of the electronic device, and wherein a second portion of the IPv4 network layer is implemented by a second IPv4 network layer included in the LwIP network stack and stored in writable-flash memory of the electronic device.

Example 8: The method of example 1, further comprising:
receiving an IPv6 packet from an IPv6 network layer;
determining that a destination address included in the received IPv6 packet matches the advertised IPv6 network route for the fabric network; and
sending the IPv6 packet to the access router in the second segment of the fabric network using the secure IPv6-over-IPv4 network tunnel, the sending being effective to direct the access router to forward the IPv6 packet to a node at the destination address in the fabric network.

Example 9: The method of any one of the preceding examples, wherein the first network segment is a Wi-Fi network segment.

Example 10: The method of any one of the preceding examples, wherein the IPv6 network route includes an IPv6 Unique Local Address (ULA) prefix for the fabric network.

Example 11: The method of any one of the preceding examples, wherein the establishing the secure IPv6-over-IPv4 network tunnel with the access router in the second network segment comprises:
establishing the secure IPv6-over-IPv4 network tunnel with the access router across an access network that is not included in the fabric network.

Example 12: The method of any one of the preceding examples, wherein the fabric network is a Connected Home over IP, CHIP, network.

Example 13: The method of any one of the preceding examples, wherein the receiving an Internet Protocol version 4, IPv4, address for an access router in a second network segment of the fabric network comprises:
receiving the IPv4 address during provisioning the electronic device; or receiving the IPv4 address during a dynamic discovery process executed by the electronic device.

Example 14: An electronic device comprising:
a network interface;
a processor; and
memory comprising instructions executable by the processor that configure the electronic device to perform the method of any of the preceding examples.

Example 15: The electronic device of example 14, wherein the network interface comprises a Wi-Fi network interface.

Example 16: A computer-readable storage media comprising instructions that, responsive to execution by a processor, cause a method as recited in any one of examples 1 to 13 to be performed.

Although aspects of adapting IPv4-only devices for IPv6 communication have been described in language specific to features and/or methods, the subject of the appended claims is not necessarily limited to the specific features or methods described. Rather, the specific features and methods are disclosed as example implementations of adapting IPv4-only devices for IPv6 communication, and other equivalent features and methods are intended to be within the scope of the appended claims. Further, various different aspects are described, and it is to be appreciated that each described aspect can be implemented independently or in connection with one or more other described aspects.

1. A method of communicating Internet Protocol version 6 (IPv6) traffic using a lightweight Internet Protocol (LwIP) network stack and a tunnel router, by an electronic device in a first network segment of a fabric network, the method comprising:
receiving an Internet Protocol version 4 (IPv4) address for an access router in a second network segment of the fabric network;
establishing a secure IPv6-over-IPv4 network tunnel with the access router in the second network segment;
advertising an IPv6 network route for the fabric network; and
using the advertised IPv6 network route, routing IPv6 messages from the electronic device to one or more devices in the second network segment using the secure IPv6-over-IPv4 network tunnel.

2. The method of claim 1, further comprising:
receiving an Internet Protocol (IP) packet from a Medium Access Control (MAC) layer;
determining that the IP packet is an IPv6 packet; and
based on the determining that the IP packet is an IPv6 packet, sending the IP packet to the tunnel router.

3. The method of claim 2, further comprising:
determining, by the tunnel router, that the IPv6 packet matches the advertised IPv6 network route; and
sending the IPv6 packet to an IPv6 network layer, the sending being effective to forward a payload of the IPv6 packet to an application at an application layer in the electronic device.

4. The method of claim 2, further comprising:
determining, by the tunnel router, that the IPv6 packet does not match the advertised IPv6 network route; and
dropping the IPv6 packet.

5. The method of claim 1, further comprising;
receiving an IP packet from a MAC layer;
determining that the IP packet is an IPv4 packet; and
based on the determining that the IP packet is an IPv4 packet, sending the IPv4 packet to an IPv4 network layer, the sending being effective to forward a payload of the IPv4 packet to an application at an application layer in the electronic device.

6. The method of claim 5, wherein the IPv4 network layer is implemented at least in part by an IPv4 network layer stored in Read-Only Memory (ROM) of the electronic device.

7. The method of claim 5, wherein the LwIP network stack includes at least part of the IPv4 network layer, wherein a first portion of the IPv4 network layer is implemented by a first IPv4 network layer stored in ROM of the electronic device, and wherein a second portion of the IPv4 network layer is implemented by a second IPv4 network layer included in the LwIP network stack and stored in writable-flash memory of the electronic device.

8. The method of claim 1, further comprising:
receiving an IPv6 packet from an IPv6 network layer;
determining that a destination address included in the received IPv6 packet matches the advertised IPv6 network route for the fabric network; and
sending the IPv6 packet to the access router in the second segment of the fabric network using the secure IPv6-over-IPv4 network tunnel, the sending being effective to direct the access router to forward the IPv6 packet to a node at the destination address in the fabric network.

9. The method of claim 1, wherein the first network segment is a Wi-Fi network segment.

10. The method of claim 1, wherein the IPv6 network route includes an IPv6 Unique Local Address (ULA) prefix for the fabric network.

11. The method of claim 1, wherein the establishing the secure IPv6-over-IPv4 network tunnel with the access router in the second network segment comprises:
establishing the secure IPv6-over-IPv4 network tunnel with the access router across an access network that is not included in the fabric network.

12. The method of claim 1, wherein the fabric network is a Connected Home over IP CHIP) network.

13. An electronic device comprising:
a network interface;
a lightweight Internet Protocol (LwIP) network stack;
a tunnel router;
a processor; and
memory comprising instructions executable by the processor that configure the electronic device to:
receive an Internet Protocol version 4 (IPv4) address for an access router in a second network segment of a fabric network;
establish a secure IPv6-over-IPv4 network tunnel with an access router in the second network segment;
advertise an IPv6 network route for the fabric network; and
using the advertised IPv6 network route, route Internet Protocol version 6 (IPv6) messages from the electronic device to one or more devices in the second network segment using the secure IPv6-over-IPv4 network tunnel.

14. The electronic device of claim 13, wherein the network interface comprises a Wi-Fi network interface.

15. (canceled)

16. The electronic device of claim 13, the instructions further executable to configure the electronic device to:
receive an Internet Protocol (IP) packet from a Medium Access Control (MAC) layer;
determine that the IP packet is an IPv6 packet; and
based on the determination that the IP packet is an IPv6 packet, send the IP packet to the tunnel router.

17. The electronic device of claim 16, the instructions further executable to configure the electronic device to:
determine, by the tunnel router, that the IPv6 packet matches the advertised IPv6 network route; and
send the IPv6 packet to an IPv6 network layer, the sending being effective to forward a payload of the IPv6 packet to an application at an application layer in the electronic device.

18. The electronic device of claim 16, the instructions further executable to configure the electronic device to:
determine, by the tunnel router, that the IPv6 packet does not match the advertised IPv6 network route; and
drop the IPv6 packet.

19. The electronic device of claim 13, the instructions further executable to configure the electronic device to:
receive an IP packet from a MAC layer;
determine that the IP packet is an IPv4 packet; and
based on the determination that the IP packet is an IPv4 packet, send the IPv4 packet to an IPv4 network layer, the sending being effective to forward a payload of the IPv4 packet to an application at an application layer in the electronic device.

20. The electronic device of claim 19, wherein the IPv4 network layer is implemented at least in part by an IPv4 network layer stored in Read-Only Memory (ROM) of the electronic device.

21. The electronic device of claim 19, wherein the LwIP network stack includes at least part of the IPv4 network layer, wherein a first portion of the IPv4 network layer is implemented by a first IPv4 network layer stored in ROM of the electronic device, and wherein a second portion of the IPv4 network layer is implemented by a second IPv4 network layer included in the LwIP network stack and stored in writable-flash memory of the electronic device.
